(19) United States
(12) Patent Application Publication
(10) Pub. No.: US 2004/0223744 A1
(43) Pub. Date: Nov. 11, 2004

(54) Method and computer device for automatically reproducing digital audio data

(76) Inventors: Peter Becker, Berlin (DE); Paul Raymond Camacho, Berlin (DE)

Correspondence Address: SUTHERLAND ASBILL & BRENNAN LLP, 999 PEACHTREE STREET, N.E., ATLANTA, GA, 30309, US

(21) Appl. No.: 10/623,463

(22) Filed: Jul. 18, 2003

(30) Foreign Application Priority Data
May 9, 2003 (DE) 10321097.0

(51) Int. Cl. H04N 5/76

(52) U.S. Cl. 386/96; 386/98

(57) ABSTRACT

The invention relates to a method and a computer device (1) to automatically reproduce digital audio data by way of an audio data reproducing means (5) comprised by the computer device (1). The computer device (1) further comprises memory means (8) for storing the digital audio data, input means including a keyboard (6) for detecting user inputs, display means (3) for the output of electronic image information, and control means (2) to control and/or monitor electronic data transfers. With the method, a respective predetermined functionality each is assigned to a plurality of key members of the keyboard (6) in connection with the automatic reproduction of the digital audio data. Reproduction of the digital audio data is controlled automatically in response to write data being entered through the keyboard (6) in connection with a write program executed in the computer device. (1).

The invention pertains to the field of methods and computer equipment by which digital audio data can be reproduced automatically.

Digital audio data may be based, for instance, on speech data which are recorded by a microphone means coupled to a computer device and which are then stored in electronic form in a memory means included in the computer equipment. The electronically memorized digital audio data are reproduced either by the same computer device or by any other reproducing means, through a suitable loudspeaker. Thus it has become possible in a wide variety of applications, for instance, during work in the legal or medical professions, to dictate and have the dictation first stored electronically by means of the computer device in the form of digital audio data and, later on, have it emitted as audio signals either by the same computer device or by any other reproducing means. As the digital audio data are output by the reproducing means, a person, such as a secretary, being a user of a write program installed ready for execution in the computer device, writes in order to obtain a written text which corresponds to the dictation. The user, when writing, actuates a switch or pedal with his/her foot in order to control the reproduction of the digital audio data, especially as regards the beginning, interruption, and end of reproduced sections of the dictation. Such a foot-operated switch or pedal must be purchased in addition to the computer equipment and connected electrically to the same. Application of a foot-operated switch in combination with the write program installed in the computer device, as a rule, requires professional skill of which trained secretarial staff disposes. Unskilled persons, on the other hand, normally are not capable of properly coordinating the reproduction of the digitally stored dictated data and the writing of the dictation to be reproduced, by actuating the foot-operated switch.

It is, therefore, an object of the present invention to provide an improved method and an improved computer device for automatically reproducing digital audio data by way of an audio data reproducing means, in particular for automatically reproducing dictated data which are stored in electronic form. The method and device are to allow also untrained users to combine reproducing of the digital audio data and writing with the assistance of a write program, at little expenditure.

These objects are met, in accordance with the invention, by a method as recited in independent claim 1 and a computer device as recited in independent claim 6.

The invention embraces the concept of using a computer device for automatically reproducing digital audio data via an audio data reproducing means, especially for automatically reproducing dictated data which are stored in electronic form. The computer device comprises a memory means for storing the digital audio data, an input means including a keyboard for detecting user inputs, a display means for the output of electronic image information, and a control unit to control and/or monitor electronic data transfers between the audio data reproducing means, the memory means, the input means with its keyboard, the display means, and/or the control unit. A respective predetermined functionality, in connection with the automatic reproduction of the digital audio data via the audio data reproducing means, is electronically assigned to plural key members of the keyboard. This is accomplished by making use of the control unit. When the control unit electronically detects that one of the plurality of key members of the keyboard has been actuated, the control unit accesses the digital audio data stored in the memory means, based on the predetermined functionality of the one of the plural key members, and automatically causes the digital audio data to be reproduced by the audio data reproducing means. For a predetermined period of time t, at first, audio signals TS1 are output which correspond at least to a subset TM1 of the digital audio data. At periodic intervals, the control unit automatically checks whether write data in connection with a write program executed in the computer device that were input via the keyboard during the output of the audio signals TS1 can be detected. If, upon completion of the output of the audio signals TS1, the control unit detects write data in connection with the write program executed in the computer device that were entered by way of the keyboard, the control unit automatically causes further audio signals TS2, corresponding to another subset TM2 which follows the subset TM1 in the stored digital audio data, to be output via the audio data reproducing means for the predetermined period of time t, immediately upon completion of the output of audio signals TS1. If not, the reproduction of the digital audio data via the audio data reproducing means is interrupted automatically.

In this manner the user of the computer device is enabled, on the one hand, to control reproduction of the digital audio data with ease by actuating key members of the keyboard in order to trigger the reproduction at least of subsets of the audio data by pushing a button. And, on the other hand, to enter write data while the digital audio data are being reproduced. All this can be done without the need for an untrained user to employ a rather difficult foot-operated switch. Dictation data thus can be reproduced automatically without having the computer device equipped with a foot-operated switch which would involve extra costs. Also, the user's writing speed can be allowed for automatically since reproduction of the digital audio data will be interrupted automatically if no entry of write data is detected at the end of the output of a certain quantity of audio signals. The reason for this measure is that an untrained user's input in terms of writing speed, as a rule, cannot follow the reproduction speed of the digital audio data. The user consequently will interrupt the input of write data. And in that event also the reproduction of audio data is stopped automatically.

Electronic assignment of the predetermined functionality to the plurality of key members of the keyboard permits different functionalities to be associated with different key members. Actuating different key members, therefore, releases the automatic reproduction of digital audio data which belong to different time portions. By operating the keyboard, the user in this manner can adjust the reproduction to his/her capability of writing texts. The invention thus not only helps save costs for a foot-operated switch which normally would be required, it also simplifies handling of the computer device. Even persons who are not skilled keyboard typists are given the chance to benefit from automatic reproductions of dictations to write the dictated text.

A convenient further development of the invention provides for interruption of the reproduction of the digital audio data by the audio data reproducing means for a predetermined period of interruption tu, and for the further audio signals TS2 to be output automatically subsequent to the period of interruption tu. In this manner the reproduction of the digital audio data can be resumed automatically after a predetermined period of interruption without the need to first having to detect a user reaction. The length of time of the interruption can be adjusted in accordance with the user's writing capabilities. For untrained users, the period of interruption will be somewhere in the range of several seconds.

In a modification of the invention, intended to improve possibilities of individual adjustment of the method to the wishes of users, it may be provided that theÿpredetermined period of time t is automatically set differently by means of the control unit, depending on the electronic determination of which one of the plurality of key members of the keyboard was actuated.

An embodiment of the invention, especially advantageous for use of the method in combination with mobile computing equipment, provides for the keyboard to be designed, with the aid of the control unit, as a display keypad on the display means. Actuation of the plural key members and the input of write data, by means of the display keypad, in connection with the write program executed in the computer device are detected electronically by the control unit.

According to a preferred further development of the invention electronic text data are shown on the display means in the course of the reproduction of the digital audio data via the audio data reproducing means, said electronic text data corresponding to electronic speech recognition data which were generated automatically by a speech recognition means on the basis of the digital audio data. This gives the user the option of utilizing electronic speech recognition in combination with the method. With this embodiment, the write data entered by the user by way of the keyboard and detected by means of the computer device, normally, relate to corrections of the electronic text data generated by speech recognition which are displayed on the display means and correspond to a text presentation of the digital audio data reproduced.

The invention will be described further, by way of example, with reference to the accompayning drawings, in which:

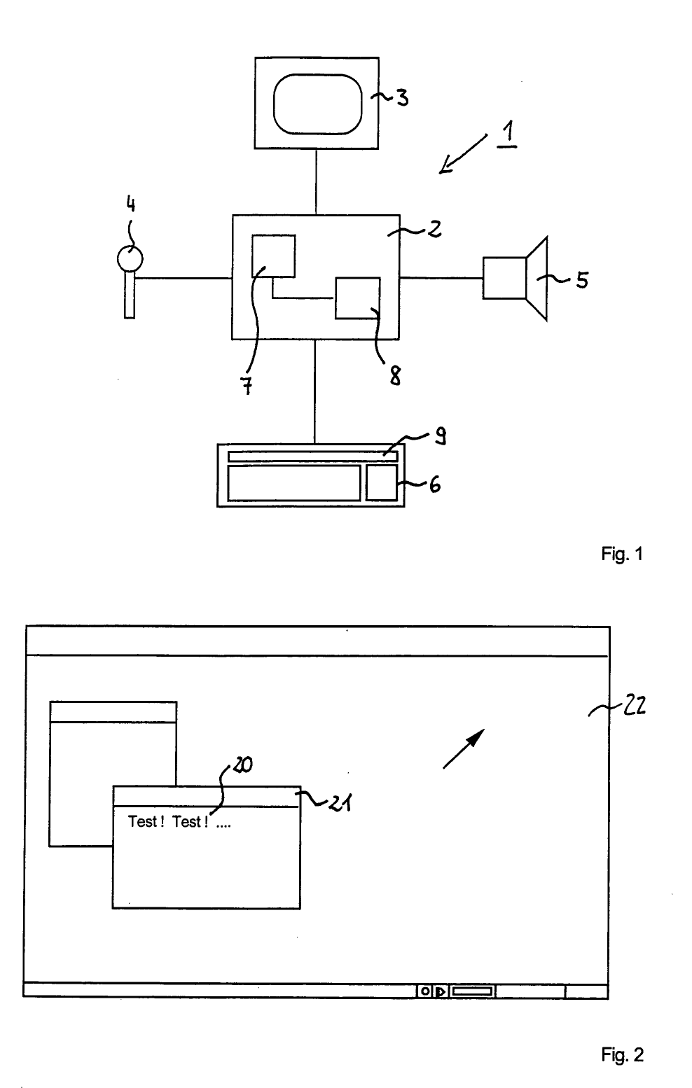

FIG. 1 is a diagrammatic presentation of a computer device for carrying out the method of automatically reproducing digital audio data;

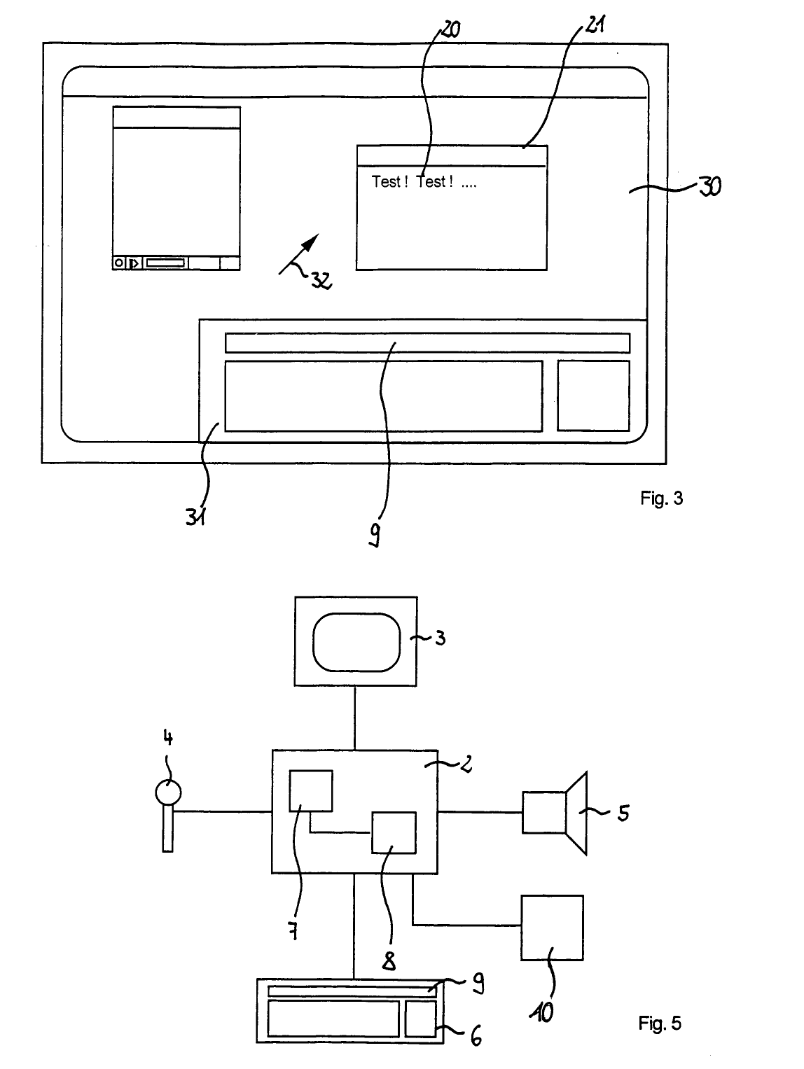

FIG. 2 is a diagrammatic presentation of part of a display surface;

FIG. 3 is a diagrammatic presentation of an integrated computer device on which a display keypad is shown;

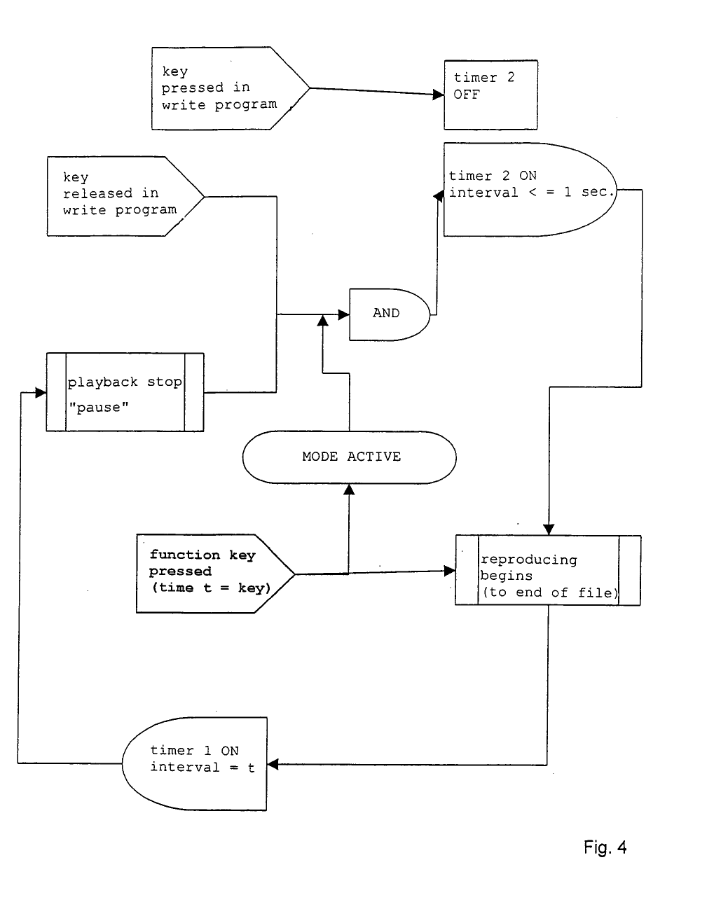

FIG. 4 is a flowchart comprising steps of the method of automatically reproducing digital audio data; and

FIG. 5 is a diagrammatic presentation of another computer device for carrying out the method of automatically reproducing digital audio data, comprising an electronic speech recognition means.

FIG. 1 diagrammatically shows a computer device 1 comprising a control unit 2 which is connected to a display means 3 for the output of electronic image information, a microphone means 4 for entering speech data, a loudspeaker means 5 for reproducing audio data, and a keyboard 6. The control unit 2 serves to control and/or monitor electronic data transfers between the control unit 2, the display means 3, the microphone means 4, the loudspeaker means 5, and/or the keyboard 6. The control unit 2 comprises a processor means 7 and a memory means 8, as is conventional with microprocessor based systems. The computer-device 1 diagrammatically shown in FIG. 1 may be a conventional desktop computer, a laptop computer, or any other mobile computer device disposing of the elements described above; it may also be a pocket computer or an electronic pocket diary system.

The presentation in FIG. 1 is diagrammaticÿin the sense that the display means 3, the microphone means 4, the loudspeaker means 5, and/or the keyboard 6 may in fact be integrated together with the control unit 2 in a common casing. The particular arrangement of the individual component groups is not critical to the invention. For instance, the microphone means 4 at the computer device 1 may be omitted and digital audio data recorded by other means and then passed on to the computer device 1 by data transfer.

The keyboard 6 includes a plurality of key members arranged in a so-called function key block 9. Therefore, the key members arranged in the function key block 9 also are referred to as function keys F1 . . . F2. As already practiced in connection with known computer programs, the function keys each may be assigned a predetermined functionality by the control unit 2. When a function key is actuated, the functionality electronically assigned to it will be executed automatically. For example, a program installed in the computer device 1 is executed while the control unit 2 performs its controlling and coordinating of the automatic course of individual steps.

The computer device 1 may be used to carry out a program for the reproduction of digital audio data, as may be gathered at least in part from the flowchart shown diagrammatically in FIG. 4. The memory means 8 holds digital audio data in electronic form which either were recorded by way of the microphone means 4 or transferred directly to the memory means 8 by electronic data transfer. The digital audio data preferably are speech data (dictation) entered by a user, such as a dictated letter. By starting a reproduction program installed in the computer device 1, the user can trigger the output of the digital audio data stored in the memory means 8 which thus will be emitted as audio signals from the loudspeaker means 5. Beforehand, a predetermined functionality had been assigned electronically to a plurality of function keys of the keyboard 6 by the control unit 2 so that actuation of one of the function keys will result in the output of a first subset TM1 of the digital audio data from the loudspeaker means 5 in the form of audio signals TS1. Due to the predetermined functionality of the function key, the first subset TM1 comprises so many audio data that the audio signals TS1 will be reproduced for a pretermined period of time t. During reproduction of the digital audio data, the control unit 2 checks whether write data entered by the user through the keyboard 6 can be detected, such data being input by the user to write a text 20 (cf. FIG. 2) in a write program 21 which is executed by the computer device 1. The write program is shown diagrammatically in FIG. 2 as an open window on a display surface 22. In the case where the reproduced digital audio data are based on a dictation of a letter, the text 20 in the write program 21 corresponds to the dictated letter.

If the control unit 2 determines, at the end of the reproduction of the first audio signals TS1, that the user is putting the keyboard 6 to use for inputting dataÿin connection with the write program 21, a second subset TM2 of the digital audio data in the form of second audio signals TS2 will be reproduced for the predetermined period of time t by the loud-speaker means 5, immediately following the end of the reproduction of the first audio signals TS1. This automatic way of proceeding is based on the assumption that the user, with his/her writing speed, can follow the dictation as reproduced through the loudspeaker means 5. Should the user interrupt the entering of write data via the keyboard 6 because he/she cannot follow theÿdictation as reproduced, the reproduction of the digital audio data through the loudspeaker means 5 is interrupted for a predetermined interruption period tu when the reproduction of the first audio signals TS1 has been completed. This is a way of giving the user a chance of subsequently writing dictation sequences still comprised by the first audio signals TS1. After the predetermined interruption period tu, which may last no more than one or several seconds, the second subset TM2 in the form of second audio signals TS2 is reproduced through the loudspeaker means 5. At the end of the reproduction of the second audio-signals TS2 the control unit 2 operates in analogous manner as at the end of the reproduction of the first audio signals TS1 to reproduce the further digital audio data.

The predetermined interruption period tu is individually adjustable by the user. Typically, a parameter option is offered as usual within the reproduction program implemented in the computer device 1.

FIG. 3 diagrammatically shows a display surface 30 on which a display keypad 31 is shown. Usually, the display keypad 31 comprises the same kind of elements as the keyboard 6, in any case at least a function key block 9. In analogy to the keyboard 6, the display keypad 31 can be used in connection with the method described above for automatically reproducing digital audio data. Either a mouse pointer 32 or an electronic pointer means (not shown) may be used to actuate the key members of the display keypad 31 with which the pointer will interact electronically as the display keypad 31 is touched or approached. It is likewise possible to use any kind of touchscreen display. With the computer device 1, the display keypad 31 may be used alone or in combination with the keyboard 6.

A further development of the method described provides for the control unit 2 to be connected to an electronic speech recognition means 10, as illustrated in FIG. 5. The electronic speech recognition means 10 serves to automatically convert electronic speech data into text data. Various speech or voice recognition programs are available to accomplish that and they can be executed in any kind of computer system. The particular embodiment of the speech recognition program applied is not critical to the invention. When the digital audio data held in the memory means 8 have been processed by the electronic speech recognition means 10, text data generated from the audio data with the aid of the speech recognition means 10 can be shown on the display means 3, while the digital audio data are being reproduced by the loudspeaker means 5. Under these circumstances the write data entered by the user either by way of the keyboard 6 or the display keypad 31 in the method described above, usually relate to corrections to be made in the text data displayed on the display means 3. Here, the user has the opportunity to read text data from the display means 3, while the digital audio data comprising, for instance, a dictated letter are being reproduced via the loudspeaker means 5. Like the other components of the computer device, the electronic speech recognition means 10 may be integrated in a casing together with the control unit 2. However, often server means disposing of sufficient processing capacity are used as the means for speech recognition.

The features of the invention disclosed in the specification above, in the claims, and in the drawing may be significant to implementing the invention in its various embodiments, both individually and in any combination.

1. A method of automatically reproducing digital audio data via an audio data reproducing means of a computer device, especially for automatically reproducing dictated, electronically stored data, the computer device further comprising a memory means for storing the digital audio data, an input means including a keyboard for detecting user inputs, a display means for the output of electronic image information, and a control unit to control and/or monitor electronic data transfers between the audio data reproducing means, the memory means, the input means with its keyboard, the display means and/or the control unit, the method comprising:
electronically assigning a respective predetermined functionality each to a plurality of key members of the keyboard in connection with the automatic reproduction of the digital audio data via the audio data reproducing means;
the control unit accessing the digital audio data stored in the memory means, based upon the predetermined functionality of one of the plural key members, and automatically causing the digital audio data to be reproduced via the audio data reproducing means upon electronic detection of an actuation of the one key member with the aid of the control unit, at first outputting, for a predetermined period of time t, audio signals TS1 that correspond to at least a subset TM1 of the digital audio data;
automatically making periodic checks with the aid of the control unit to see whether write data can be detected which were input via the keyboard in connection with a write program executed in the computer device during the output of the audio signals TS1;
immediately upon completion of the output of the audio signals TS1, the control unit automatically causing further audio signals TS2 that correspond to another subset TM2, successive to subset TM1 of the digital audio data, to be output via the audio data reproducing means for the predetermined period of time t, if write data which were input through the keyboard in connection with the write program executed in the computer device are detected with the aid of the control unit upon completion of the output of the audio signals TS1; and, if not, the reproduction of the digital audio data via the audio data reproducing means being interrupted automatically.

2. The method as claimed in claim 1, wherein reproducing of the digital audio data via the audio data reproducing means is interrupted for a predetermined interruption period tu, and subsequent to the interruption period tu the further audio signals TS2 are output automatically.

3. The method as claimed in claim 1, wherein the predetermined period of time t is automatically set differently with the aid of the control unit (2), depending on which of the plural key members of the keyboard was electronically detected to have been actuated.

4. The method as claimed in claim 1, wherein the keyboard is implemented with the aid of the control unit as a display keypad on the display means, and actuation of the plural key members as well as the input of write data via the display keypad in connection with the write program executed in the computer device are detected electronically by the control unit.

5. The method as claimed in claim 1, wherein electronic text data are shown on the display means in the course of the reproduction of the digital audio data via the audio data reproducing means, said electronic text data corresponding to electronic speech recognition data which were generated automatically with the aid of a speech recognition means on the basis of the digital audio data.

6. A computer device, comprising
an audio data reproducing means for reproducing digital audio data;
a memory means for electronically storing the digital audio data;
a display means for the output of electronic image information;
an input means including a keyboard for use by a user to produce inputs; and
a control unit to control and/or monitor electronic data transfers between the audio data reproducing means, the memory means, the input means with its keyboard, the display means and/or the control unit, the control unit comprising:
assigning means to electronically assign a respective predetermined functionality each to a plurality of key members of the keyboard in connection with the automatic reproduction of the digital audio data via the audio data reproducing means;
accessing means to access the digital audio data stored in the memory means, based upon the predetermined functionality of one of the plural key members;
controlling means to automatically cause the digital audio data to be reproduced via the audio data reproducing means upon electronic detection of an actuation of the one key member with the aid of detecting means, at first outputting, for a predetermined period of time t, audio signals TS1 that correspond to at least a subset TM1 of the digital audio data; and
checking means to automatically check periodically whether write data which are input via the keyboard in connection with an implemented write program during the output of the audio signals TS1 can be detected;
the controlling means being implemented so as to automatically cause further audio signals TS2 that correspond to another subset TM2, successive to subset TM1 of the digital audio data, to be output via the audio data reproducing means for the predetermined period of time t, immediately upon completion of the output of the audio signals TS1, if write data which are input through the keyboard in connection with the implemented write program upon completion of the output of the audio signals TS1 are detected with the aid of the checking means; and, if not, to automatically interrupt the reproduction of the digital audio data via the audio data reproducing means.
